(19) United States
(12) Patent Application Publication
(10) Pub. No.: US 2026/0210161 A1
(43) Pub. Date: Jul. 23, 2026

(54) VEHICLE INLET PORT DOOR ACTUATION

(71) Applicant: MCi (Mirror Controls International) Netherlands B.V., Woerden (NL)

(72) Inventors: Marius BRAND, Amersfoort (NL); Stephen Alexander George Gustavo BOOM, Zeist (NL)

(73) Assignee: MCi (Mirror Controls International) Netherlands B.V., Woerden (NL)

(21) Appl. No.: 19/139,158

(22) PCT Filed: Dec. 15, 2023
(86) PCT No.: PCT/NL2023/050666

§ 371 Date: Jun. 13, 2025

(30) Foreign Application Priority Data
Dec. 15, 2022 (NL) 2033731

(51) Int. Cl. E05B 83/34; E05B 81/62; E05B 81/68; E05B 81/70

(52) U.S. Cl. CPC E05B 83/34; E05B 81/62; E05B 81/68; E05B 81/70; E05Y 2900/534

(57) ABSTRACT

Closing and opening, as well as locking and unlocking, of a door of an inlet port of a vehicle for an entry for providing the vehicle with energy may be actuated in concertation. An electromechanical door driver closes the door and upon sensing that the door is closed, the door is locked by an electromechanical lock driver. Likewise, the electromechanical lock driver unlocks the door, and upon sensing that the door is unlocked, the electromechanical door driver opens the door. Whether the door is locked or not, may be detected by sensing whether the door moves upon controlling the door driver. For the control function, an electronic controller may be provided in the housing with one of the electromechanical door driver and the electromechanical lock driver. The housing with the controller may be provided with a sensor for sensing door position or with an inlet for such sensor.

### TECHNICAL FIELD

The various aspects of this disclosure and embodiments thereof relate to operating a vehicle inlet port door.

### BACKGROUND

Controlling a door of an inlet port, such as a fuel port or an electrical port, in a vehicle may be performed by operating a door actuator and a lock actuator. Such actuation may be a release of a latch locking a spring loaded door of the inlet port by means of operating a solenoid connected to the latch. With the latch retracted from holding the door in closed position, the door opens by virtue of urging of a spring.

### SUMMARY

It is preferred to provide a more robust way of operating the inlet port door to increase reliability.

A first aspect provides a method of operating, by means of an electronic processing circuit, a door actuator comprising a door electromagnetic driver and a lock actuator comprising a lock electromagnetic driver in response to an activation signal. In this method, the door actuator is connected to a door of a vehicle inlet port and arranged to open and close the door and the lock actuator is connected to a lock of the vehicle inlet port and arranged to lock and unlock the door if the door is in a closed position. The method comprises receiving the activation signal, upon receiving the activation signal, operating, via the electronic processing circuit, a first of the door actuator and the lock actuator to perform a first actuation operation, receiving a sensing signal indicative of progress of the first actuation operation, determining, based on the sensing signal, whether the first actuation operation has finished and, upon determining that the first actuation operation has finished, operating, via the electronic processing circuit, a second of the door actuator and the lock actuator to perform a second actuation operation.

By making the one operation leading and the other following, addressable actuators may used for performing the locking or unlocking operation and the closing or opening operation. This, in turn, provides more reliable and controllable operation compared to the mere use of a spring to open a door. Furthermore, it allows for remote closing of a door of the inlet, which is not possible if the door is only spring loaded towards the opening position.

When the door is to be opened, the unlocking of the door is leading and the opening of the door follows upon determining that the door has been unlocked; when the door is to be closed, the closing of the door is leading and the locking of the door follows up on determining that the door has been closed.

In an example, receiving the sensing signal comprises obtaining a value related to an electrical parameter of the electromagnetic driver of the first of the door actuator and the lock actuator; and determining that the first actuation operation has finished comprises comparing the measured value to a first predetermined threshold value; and based on the outcome of the comparing, determining whether or not the first actuation operation has finished. If the door or a locking member of the lock, like a bolt, has reached an endpoint, the electromagnetic or electromechanical driver, like an electromotor, may stall. This may be detected in a supply current or supply voltage.

In another example, obtaining the value related to the electrical parameter comprises detecting variations in a first supply current of the electromagnetic driver of the first of the door actuator and the lock actuator, resulting in detected variations; and the method further comprises, based on the detected variations, determining whether or not the first actuation operation has finished. This example is in particular applicable to a use case with DC—direct current—electromotors. During a driving operation, ripples may be detected in the supply current. When a particular amount of ripples has been counted, it may be determined that the door is fully open or fully closed and, for an electromotor driving the lock, it may be determined that the lock locks or unlocks the door after a particular amount of ripples has been counted. Alternatively or additionally, absence of ripples after some ripples may mean that the electromotor stalls as a locking member or the door has reached an endpoint, which means that the applicable operation has finished. In one example, it may be determined that at least one of a lock and an inlet port has reached an end position. For the lock, the end position may be at least one of a fully locked position and a fully unlocked position and for the inlet door, this may be one of a fully open and a fully closed position.

In again another example, a first sensor is provided arranged to generate the sensing signal, based on a position of a first moving part comprised by the first of the door actuator and the lock actuator, the method further comprises receiving the sensing signal from the first sensor; and the determining that the first actuation operation has finished is based on a sensing signal value of the sensing signal. This example may be implemented using potentiometers or switches, which switches are actuated upon at least one of the door and the lock—a locking member like a bolt—reaches one or more endpoints.

Yet a further example further comprises performing a tolerance check comprising obtaining, from the sensing signal, a value of a range parameter, indicating a range of movement of the door actuator or the lock actuator; determining whether or not the value falls within a predetermined tolerance interval; and based on the outcome of the determining, determining whether or not the tolerance check was successful; in dependence of the tolerance check, determining whether or not the door or the lock moves within the predetermined tolerance interval. Such tolerance check provides calibration data for improving operation of the system.

A second aspect provides a computer program product comprising instructions enabling a door actuation device comprising a first memory and a lock actuator device comprising a second memory, to execute a method according to the first aspect.

A third aspect provides a non-transitory medium having stored thereon the computer program product of the second aspect.

A fourth aspect provides a lead actuator for operating a lead part, wherein the lead part comprises one of a door of a vehicle inlet port and a lock arranged to lock the door. The lead actuator comprises a lead electromagnetic driver, a lead sensor inlet arranged to receive, from a lead sensor, a lead sensor signal indicating a lead position of the lead part, a driving outlet arranged to provide a drive signal to the follow electromagnetic driver and a processing unit. The processing unit is arranged to drive the lead electromagnetic driver, receive the lead sensor signal, determine, based on the lead sensor signal, that the lead part has reached a destination lead position, upon determining that the lead part has reached the destination lead position, drive the follow electromagnetic driver. It is noted that whereas this lead actuator is characterised as being leading, this lead actuator may also be following an action performed by the follow electromagnetic or electromechanical driver. Which action by the follow electromagnetic or electromechanical driver is controlled or driven by the processing unit of this lead actuator.

An example of the fourth aspect further comprises a follow sensor inlet arranged to receive, from a follow sensor, a follow sensor signal indicating a follow position of a follow part, wherein the processing unit is further arranged to drive the follow electromagnetic driver, determine, based on the follow sensor signal, that the follow part has reached a destination follow position and, upon determining that the follow part has reached the destination follow position, stop driving the follow electromagnetic driver. This example allows to fully finalise and stop the system upon finalisation of a set of actions.

In another example, the processing unit is further arranged to upon determining that the lead part has reached the destination lead position, stop driving the lead electromagnetic driver. This example allows to fully finalise and stop the system upon finalisation of a set of actions.

In yet a further example, the processing unit is further arranged to: drive the follow electromagnetic driver, upon determining that the follow part has reached the destination follow position, drive the lead electromagnetic driver. This example acts as discussed above; the electromechanical driver of the lead actuator is not necessarily always providing the leading action. This improves flexibility of the system.

In again another example, at least one of the lead electromagnetic driver and the follow electromagnetic driver comprises a solenoid with a core arranged to translate within the solenoid. A pivoting door may, as an example, be operated by means of an electromotor, a bolt of a lock may, as an example, be operated by means of a bi-directional solenoid with a reciprocating core. And further examples are provided below, in the detailed description.

A fifth example provides a vehicle comprising an inlet port for receiving energy for propelling the vehicle, a door for covering the inlet port; a lock for locking the door, a door actuator according to the fourth aspect; and a lock actuator for operating the lock, connected to the door actuator.

### BRIEF DESCRIPTION OF THE DRAWINGS

The various aspects and embodiments thereof will now be further elucidated in conjunction with drawings. In the drawings,

FIG. 1: shows a vehicle comprising a door of a vehicle inlet port;

FIG. 2: shows a schematic view of an actuator;

FIG. 3: shows a diagram depicting a system with a door actuator and a lock actuator;

FIG. 4: shows a first flowchart depicting an opening operation;

FIG. 5: shows a second flowchart depicting a closing operation; and

FIG. 6: shows a third flowchart depicting an calibration operation;

### DETAILED DESCRIPTION

FIG. 1 shows a car 100 as a vehicle according to one of the aspects of the disclosure. The car 100 comprises an inlet door 112 providing access to an inlet port arranged to receive energy for powering one or more engines or motors of the car 100. Such may be internal combustion engines, electromotors, other, or a combination thereof. The energy may be provided by means of electrical current, a flow of fuel, like petrol or hydrogen, other, or a combination thereof.

The inlet door 112 may be secured by means of a lock 114. The door 112 may be secured in at least one of an open position or a closed position. The door 112 may be a sliding door or a pivoting door. The lock 114 may be provided by means of a bolt as a locking member that is arranged to slide into and out of a hole provided in the door 112. Additionally, or alternatively, the lock 114 may block movement of a hinge by means of which the door 112 may be connected to the car 100.

Additionally, or alternatively, the lock 114 may be implemented by means of a magnetic lock, by providing a magnetic field that attracts the door 112 with a force that is higher than can generally be created by a human body to open the door.

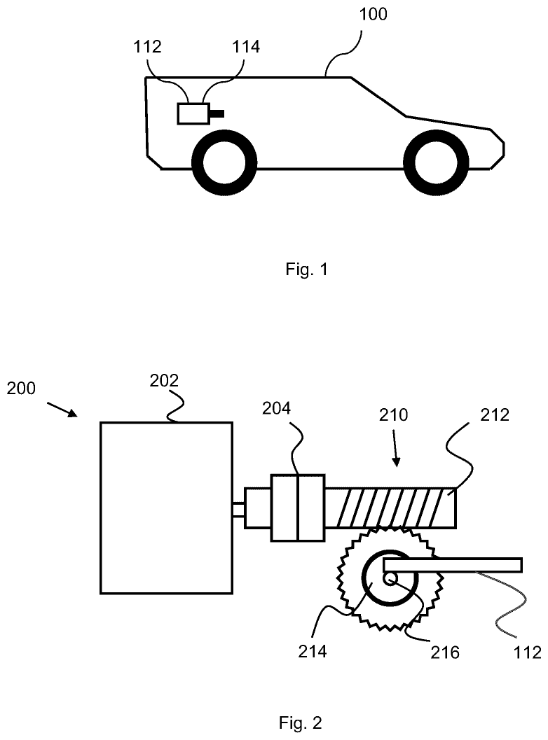

FIG. 2 shows part of a door actuator 200. The first actuator comprises a first electromotor 202 as a first electromechanical driving unit that is coupled to the door 112 via a drive train 210. The first electromotor 202 may be a commonly known brushed DC electromotor as generally commercially available. Additionally, or alternatively, a brushed or brushless AC electromotor, a linear electromotor, a solenoid with a core arranged to translate or different electromechanical actuators may be provided as electromechanical driving units.

The drivetrain 210 comprises a slip coupling 204 provided between the first electromotor 202 and a worm wheel 212. The drivetrain 210 further comprises a toothed wheel or a gear 214 that is preferably provided on an axle 216. The connection between the worm wheel 210 and the gear 214 allows for a signification reduction in rotational speed, preferably in the order or a factor 50. Also, other types of drivetrains may be used, comprising gears, racks, pullies, other, or a combination thereof.

Whereas in this embodiment the electromotor 100 is used for actuating the door 112, in other embodiments other actuatable parts of a car or other motorised vehicle may be actuated, for example the lock 114.

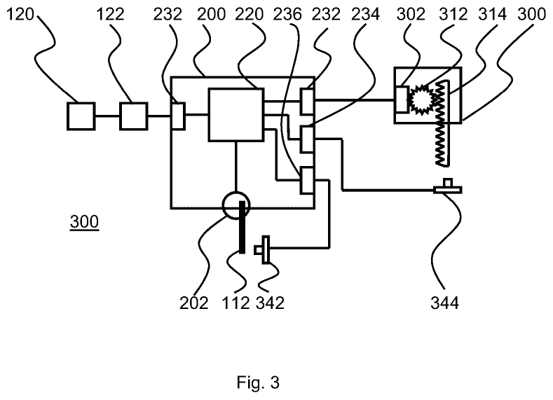

FIG. 3 shows further parts of the door actuator in conjunction with a door operating system 300. The door actuator 200 further comprises a processing unit 220 arranged to provide a driving signal to the first electromotor 202. The processing unit 220 may be arranged to monitor the waveform of at least one of current and voltage provided to the first electromotor 202.

The door actuator 200 further comprises a command inlet 232 arranged to receive an activation signal from a vehicle controller 120, via a vehicle network 122, like a CAN bus. The activation signal may comprise commands like unlocking and opening of the door 112 and closing and locking of the door 112.

The door actuator 200 comprises a driving outlet arranged to drive a second electromotor 302 as a second electromechanical driving unit comprised by a lock actuator 300. The lock actuator 300 further comprises a lock transmission comprising a gear 312 connected to and drivable by the second electromotor 302 and a rack 314 engaging with the gear 312. The rack 314 may be connected to a bolt arranged to lock the door 112, preferably in a closed position, but optionally in an open position as well. The second electromechanical driving unit may also be embodiment by comprising a brushed or brushless AC electromotor, a linear electromotor, a solenoid with a core arranged to translate or different electromechanical actuators.

The second electromotor 302 is in this implementation provided with a supply current via the processing unit 220. The processing unit 220 may directly provide such supply current, by means of a power switching module or a combination thereof. The processing unit 220 may be arranged to sense or otherwise determine a waveform of at least one of the current and voltage supplied to the second electromotor 302.

FIG. 3 further shows a door sensor 342 and a lock sensor 343. In this implementation, the door sensor 342 is implemented as a switch and arranged to provide a signal to the processing unit 220, via a second sensor inlet 236, if the door 122 is in an open outer position. In other implementations, further or alternative door sensors may be provided that are arranged to provide a signal if the door is in its outer closed position. In other implementations, additionally or alternatively, a sensor may be provided that provides a signal proportional to an opening movement of the door 122, for example proportional to an opening angle in case of a pivoting door.

In again other implementations, in particular applicable if the first electromotor 202 is a brushed DC motor, a sensor may be provided that counts ripples in the supply current; the amount by which the door 122 is open, may be determined based on an amount of ripples counted. Also, a combination of two or more of these examples of door sensors may be implemented together.

FIG. 3 also shows a lock sensor 344. The lock sensor may, like the door sensor 342 as depicted by FIG. 3, provide a binary signal depending on a position of the rack 314, the bolt driven by the rack 314 or another part of the lock 114. One or more signals may be provided if the lock is fully unlocked, fully locked, or a combination thereof. To support this, one or more additional sensor may be provided. Further sensors, as discussed in conjunction with the door sensor 342, may be used, for providing a signal having a value indicating positions of the bolt or another locking member between outer positions.

Depending on how the door sensor 342 and the lock sensor 344 are to be used and what different positions of a locking member and the door 112 are required to be assessed, one or more sensors may be used for the door and the lock. The sensors may be implemented as switches or other proximity sensors like Hall sensors, that are actuated if the door and/or the lock are provided in outer positions; open or closed, locked or unlocked. Additionally, or alternatively, potentiometers or other types of angular sensors may be used.

In this implementation, the door actuator 200 is provided as a leading actuator, with the processing unit 220 and connectors for the driving signal and the sensor signals. In other implementation, the lock sensor 344 may be provided as a lead sensor or smart sensor, with the processing unit 220 and the connectors for the signals. Or, otherwise put, the depicted door actuator 200 may in another implementation be used for actuation of the lock 114, making it, as the smart sensor, the lock actuator, rather than the door actuator. In such implementations, the actuator depicted by FIG. 3 as the lock actuator may be used as the door actuator, rather than as the lock actuator.

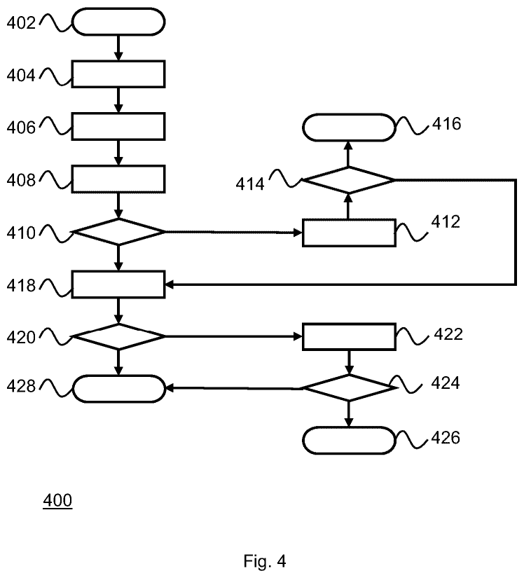

FIG. 4, shows a first flowchart 400 depicting an exemplary method for opening the inlet port door 112. The various parts of the first flowchart 400 are briefly summarised below:
402 receiving opening signal from the vehicle controller
404 sending unlocking signal to the lock actuator
406 receiving unlocking signal by the lock actuator
408 drive the lock actuator
410 determining if the lock is in the outer position
412 keep driving
414 reached end position after time?
416 sending an error signal to the vehicle controller
418 drive the door actuator
420 determining if the door is in the outer position
422 keep driving
424 door actuator has reached an end position after time?
426 sending an error signal to the vehicle controller
428 sending a completion signal to the vehicle controller

The processed depicted by the first flowchart 400 starts by receiving activation signal from the vehicle controller 120. The activation signal is in this example an opening signal, received by the processing unit 220 from the vehicle controller 120 in step 402. This is followed by step 404, wherein an unlocking signal is sent, via the processing unit 220, to the lock actuator 300, and step 406, wherein the unlocking signal is received by the lock actuator 300 and used for driving or operating the second electromotor 302. The lock actuator 300 then unlocks the lock in step 408.

Next, in step 410, it is determined if the lock actuator 300 and the second electromotor 302 stops moving, as an example of checking whether the bolt of the lock is in an outer position or otherwise in a destination position or desired position, meaning that the unlocking operation has finished. Additionally, or alternatively, the processing unit 220 may determine, based on a signal from the lock sensor 343 or a value of the sensor from the lock sensor 343, that the lock is at the destination position or not.

In case it is determined that the lock actuator has not stopped moving or it is otherwise determined that the lock is not at the destination position and the unlocking operation has not finished, the procedure may move to step 412, wherein the second electromotor 302 is driven again, optionally with increased power compared to step 408. In step 414 is checked whether or not the lock actuator has reached a locking end position as a destination position after a pre-determined amount of time. If not, a lock jam error signal may be sent to the vehicle controller 120 in step 416, for example by the processing unit 220 of the door actuator 200.

If the lock 300 actuator and/or the bolt of the lock 114 in particular has reached the locking end position, the method 400 continues with step 418, by opening the door 112 by means of the door actuator 200 and in particular by driving or operating the first electromotor 202. Further, it is determined whether the first electromotor 202 of the door actuator 200 stops moving, in step 420 by reaching an end point or a destination position, meaning that the door opening operation has finished.

Such destination position of the door actuator 200 and/or of the door 122 may result in the first electromotor 202 to stall and hence, to stop moving. This may be determined by absence of ripples in a supply current to a DC motor. Additionally or alternatively, it may be checked in step 424 whether, based on a signal received from the door sensor 342, whether the door 112 has reached its destination position, i.e. whether the door is sufficiently open, and that the operation has finished.

If it is detected that at least one of the door 112 and the first electromotor 202 has reached the destination position, the method 400 ends with step 428, wherein a completion signal is sent to the vehicle controller 120, indicating that the door 112 has been successfully opened and the opening operation is finished. However, if it is not determined that the door actuator has stopped moving or it is otherwise determined that the door 112 has not reached its destination position, the method turns to step 422, wherein one or more previous steps are repeated including continuing or restarting driving the first electromotor 202, optionally with increased power, followed by step 424, wherein it is determined whether or not at least one of the door 112, the door actuator 200 and the first electromotor 202 has reached an end position, as discussed above.

If it is determined that the at least one of the door 112, the door actuator and the first electromotor 202 has reached an end position, the method proceeds with step 428, hereby ending the method 400. If not, the method ends with step 426, by sending a door jam error signal to the vehicle controller.

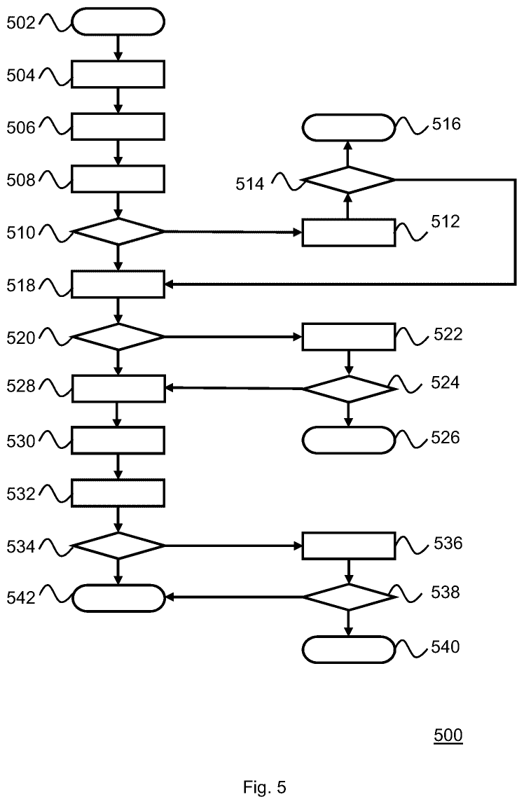

FIG. 5 shows a second flowchart 500 depicting an exemplary method for closing the inlet port door 112. The various parts of the second flowchart 500 are briefly summarised below:
502 receiving closing signal from the vehicle controller
504 sending unlocking signal to the lock actuator
506 receiving unlocking signal by the lock actuator
508 drive the lock actuator
510 determining if the lock is in the outer position
512 keep driving
514 reached an end position after time?
516 sending an error signal to the vehicle controller
518 drive the door actuator
520 determining if the door is in the outer position
522 keep driving
524 door actuator has reached an end position after time?
526 sending an error signal to the vehicle controller
528 sending locking signal to the lock actuator
530 receiving locking signal by the lock actuator
532 locking the lock by the lock actuator
534 determining if the lock actuator stops moving
536 re-try
538 checking whether or not the lock actuator has reached an end position
540 sending an error signal to the vehicle controller
542 sending a completion signal to the vehicle controller

The process depicted by the first flowchart method 500 starts with receiving the activation signal. The activation signal is in this example a closing signal, from the vehicle controller 120, in step 502, to the processing unit 220. Next, steps 504, 506 and 508 respectively comprise sending, by the processing unit 220, an unlocking signal to the lock actuator 300, receiving the unlocking signal by the lock actuator 300 and unlocking of a lock by the lock actuator 300 and the second electromotor 302 in particular.

The unlocking signal provided to the second electromotor 302 is provided for driving or operating the second electromotor 302, in order to unlock the lock 114. It is noted that for the closing operation, the unlocking of the lock 114 is optional and only required if the door 112 is locked in the open position.

Next, the procedure moves to step 510, wherein it is determined if the lock actuator 300 stops moving. As discussed, the stopping of the moving of the locking actuator 300 and the second electromotor 302 in particular, may indicated that the lock is locked or unlocked, for example because a bolt, driven by the second electromotor 302 has reached a destination position, meaning that the operation has finished.

The reaching of the destination position may also be determined by means of the lock sensor 343, by determining that ripples in supply current for the second electromotor 302 has reached a particular amount, other, or a combination thereof. In another implementation, detection that no ripples occur anymore may be used as an indication that the second electromotor 302 and/or a locking member like a bolt has reached a destination position, meaning that the operation has finished.

If it is determined that the lock actuator 300 does not stop moving or it is otherwise determined that the destination position of a locking member like the bolt has not been reached, the method executes step 512, comprising continuing or restarting driving the second electromotor—or another electromechanical driver—, optionally with higher power than before. Step 512 is followed by step 514, wherein it is checked whether or not the lock actuator 300 or a locking member comprised by the lock 114 has reached an end position.

If it is determined that the lock actuator 300 did not reach the end position, the method may end with step 516 by sending a lock jam signal to the vehicle controller 120, indicating that the lock has not functioned properly. Otherwise, the method proceeds with step 518. If, in step 510, it is determined that the lock actuator 300 and the second electromotor 302 in particular stops moving, the method 500 also proceeds with step 518. In step 518, the door 112 is closed by the door actuator 200 in the same way as the door 112 is opened as discussed above, by operating or driving the first electromotor 202 by means of a signal from the processing unit 220.

Step 520 subsequently comprises determining if the door actuator 300 stops moving or determining otherwise whether the door 112 has reached its destination position: the door 112 being closed, covering the inlet port. If it is determined that the door actuator 200 stops moving or the processing unit 220 otherwise detects that the door 112 has closed or covers the inlet port, the procedure turns to step 528. If not, step 522 is executed, comprising continuing or restarting driving the second electromotor 302, followed by step 524, wherein it is checked whether or not the door actuator 200 has reached an end position or the door 112 has otherwise reached its destination position.

If it is found that the door 112 has not reached its destination position, the procedure depicted by the second flowchart 500 may end by sending a door jam signal to the vehicle controller 120 in step 526, indicating that the door is not functioning properly. If the door actuator is found to have reached the end position, the method 500 proceeds with steps 528, 530 and 532, respectively comprising sending a locking signal to the lock actuator 300 for driving the second electromotor 302, for example by the door actuator 200, via the processing unit 220, receiving the locking signal by the lock actuator 300 and locking a lock of the door 112 by means of the lock actuator 300, by driving the second electromotor 302.

The procedure then determines whether the lock actuator 300 stops moving or whether the lock 114 has otherwise locked the door 112 in step 534. If so, step 542 is executed next. If it is determined that the lock actuator 300 and the second electromotor 302 does not stop moving or a locking member comprised by the lock 114 has otherwise not reached its destination position, one or more previous steps are re-tried in step 536.

This is followed by checking whether or not the lock actuator 300 and the second electromotor 302 and/or the locking member of the lock 114 has reached an end position in step 538. If not, a door jam signal is sent to the vehicle controller 120 in step 540, for example by the door actuator 200, by means of the processing unit 220, indicating that the door operation is not functioning correctly, that the door 112 is not locked or that the lock 114 has not locked the door 112.

If the lock actuator 300 is found to have reached the end position in step 538, the method proceeds with step 542, in which step the processing unit 220 sends a completion signal to the vehicle controller 120 and the procedure ends.

Optionally, a lock verification may be executed prior to sending the completion signal. The lock verification may be executed following or instead of step 538 and/or step 534. A lock verification may be executed by instructing the first electromotor 202 of the door actuator to perform an opening act. Subsequently, it may be verified whether the inlet door 112 moves towards an open position—or not. Such may be determined by monitoring the supply current of the first electromotor 202 and in particular, in case of a brushed DC motor, whether ripples are detected, due to rotor-commuter transitions.

Alternatively or additionally, further sensors may be available to be checked to determine whether at least one of the first electromotor 202 and the inlet door 112 moves or not. This optional step, in addition or as alternative to verifying position of at least one of the lock actuator 300 and the second electromotor 302 in particular and the lock 114, allows for verification whether the door is lock or not and may thus be performed without a sensor for determining operation of the lock actuator 300 and the second electromotor 302 in particular and of the lock 114.

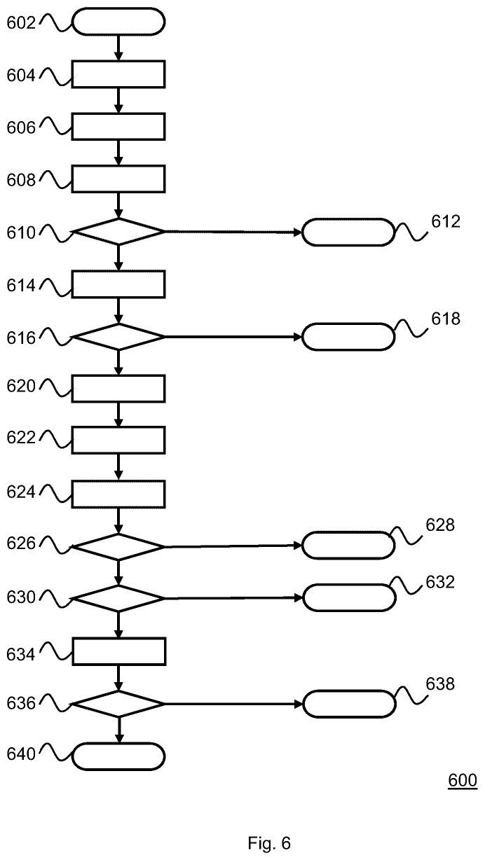

FIG. 6, shows a third flowchart 600 depicting an exemplary method for calibrating the inlet port door 112. The various parts of the third flowchart 600 are briefly summarised below:
602 receiving the calibration signal from the vehicle controller
604 sending unlocking signal to the lock actuator
606 receiving unlocking signal by the lock actuator
608 unlocking the lock by the lock actuator
610 determining if the lock actuator stops moving
612 sending an error signal to the vehicle controller
614 closing the door by the door actuator
616 determining if the door actuator stops moving
618 sending an error signal to the vehicle controller
620 sending a locking signal to the lock actuator
622 receiving the locking signal by the lock actuator
624 locking of the lock by the lock actuator
626 determining if the lock actuator stops moving
628 sending an error signal to the vehicle controller
630 checking whether rotation angle of lock actuator is within tolerance
632 sending an error signal to the vehicle controller
634 opening the door by the door actuator
636 checking whether movement of the door actuator is within tolerance
638 sending an error signal to the vehicle controller
640 sending a completion signal to the vehicle controller

Execution of the procedure depicted by the third flowchart 600 is prompted, in step 602, by receiving a calibration signal from the vehicle controller 120, for example by the door actuator 200. In step 604, an unlocking signal is then sent to the lock actuator 300, for example by the processing unit 220 of the door actuator 200. Further, in step 606, the unlocking signal is received by the lock actuator 300, which then unlocks the lock 114 of the door 112 in step 608.

It is subsequently determined if the lock actuator 300 and the second electromotor 302 in particular stops moving in step 610, which may be an indication that a destination of a locking member like a volt of the lock 114 has been reached, as discussed above. In case it takes longer than a first predetermined timing threshold before the locking member or the electromotor 302 reached the destination position, in step 612 a first timing error signal may be sent to the vehicle controller 120, for example by the door actuator, in which case the method may end.

It is also possible to re-execute step 610 after a while and possibly also other steps, for example steps 604-508, and this may be repeated several times. When, after one or more times re-executing these steps, it is determined that the lock actuator has stopped moving, the method proceeds with step 614, wherein the door 112 is closed by the door actuator 200. This is followed by step 616, wherein it is determined if the door actuator 300 and the electromotor 302 in particular stops moving or it is otherwise detected that the door actuator and the electromotor 302 or the door 112 has reached a destination position.

In case this takes longer than a second predetermined timing threshold, in step 618 a second timing error signal may be sent to the vehicle controller 120, for example by the processing unit 220 of the door actuator 200, optionally ending the procedure discussed here. It is also possible to re-attempt step 616 after some time and possibly also other steps such as for example step 614, and this may be repeated several times.

When it is determined that the door actuator 200 and the first electromotor 202 in particular or the door 112 has stopped moving, step 620 is initiated, wherein a locking signal is sent to the lock actuator 300, for example by the processing unit 220 of the door actuator 200. Upon receiving the locking signal by the lock actuator 300—meaning, here as well as in equivalent steps above, that the second electromotor 302 receives a driving signal to either lock or unlock the door 112, in step 622, a lock of the inlet port door 112 is locked in step 624 by the lock actuator 300.

In step 626, it is determined if the lock actuator 300 and the electromotor 302 or a locking member like a bolt of the lock 114 stops moving as a sign the electromotor 302 or a locking member like a bolt of the lock 114 has reached a destination position. In case it is determined that the lock actuator 300 has not stopped moving or it is otherwise detected that at least one of the second electromotor 302 or the locking member has not reached the intended destination position, exceeding a third predetermined timing threshold may end the method in step 628 by sending a first movement error signal to the vehicle controller 120.

It is possible to re-try step 626 and possibly previous steps once or multiple times, as discussed above. If it is determined, based on a signal of the lock sensor 344, that the lock actuator 300 has stopped moving or the locking member or the second electromotor 302 has reached its destination position, the procedure proceeds with step 630, wherein it is checked if a movement, for example a rotation angle, of the lock actuator 300 and at least one of the second electromotor 302 and the locking member in particular, falls within a first predetermined tolerance range.

In case the movement, for example the rotation angle, is not comprised by the first predetermined tolerance range, the procedure may end by sending a second movement error signal to the vehicle controller 120 in step 632, optionally after re-running one or more previous steps. Upon determining that the movement resides within the first predetermined tolerance range, the procedure moves on to step 634, opening the door by the door actuator.

Next, in step 636, it is checked whether a movement of the door actuator falls within a second predetermined tolerance range, for example by means of the door sensor 242. If the movement of the door does not comply with the second predetermined tolerance range, the method may end by sending a third movement error signal to the vehicle controller 120, for example by the processing unit 220 of the door actuator 200, in step 638.

Should the movement of the door 112 be within the second predetermined tolerance range, the procedure ends in step 640 by sending a completion signal to the vehicle controller, for example by the door actuator, indicating that the calibration of the inlet port door 112 of the vehicle 100 was successful.

At least some examples relate to closing and opening as well as locking and unlocking of a door of an inlet port of a vehicle for an entry for providing the vehicle with energy that may be actuated in concertation. An electromechanical door driver closes the door and upon sensing that the door is closed, the door is locked by an electromechanical lock driver. Likewise, the electromechanical lock driver unlocks the door and upon sensing that the door is unlocked, the electromechanical door driver opens the door. Whether the door is locked or not, may be detected by sensing whether the door moves upon controlling the door driver. For the control function, an electronic controller may be provided in the housing with one of the electromechanical door driver and the electromechanical lock driver. The housing with the controller may be provided with a sensor for sensing door position or with an inlet for such sensor.

1. A method of operating, by means of an electronic processing circuit, a door actuator comprising a door electromagnetic driver and a lock actuator comprising a lock electromagnetic driver in response to an activation signal, the door actuator being connected to a door of a vehicle inlet port and arranged to open and close the door and the lock actuator being connected to a lock of the vehicle inlet port and arranged to lock and unlock the door if the door is in a closed position;
the method comprising:
receiving the activation signal;
upon receiving the activation signal, operating, via the electronic processing circuit, a first of the door actuator and the lock actuator to perform a first actuation operation;
receiving a sensing signal indicative of progress of the first actuation operation;
determining, based on the sensing signal, whether the first actuation operation has finished; and
upon determining that the first actuation operation has finished, operating, via the electronic processing circuit, a second of the door actuator and the lock actuator to perform a second actuation operation.

2. The method according to claim 1, wherein the first actuation operation comprises unlocking the door and the second actuation operation comprises opening the door.

3. The method according to claim 1, wherein the first actuation operation comprises closing the door and the second actuation operation comprises locking the door.

4. The method according to claim 1, wherein
receiving the sensing signal comprises obtaining a value related to an electrical parameter of the electromagnetic driver of the first of the door actuator and the lock actuator; and
determining that the first actuation operation has finished comprises: comparing the measured value to a first predetermined threshold value; and
based on the outcome of the comparing, determining whether or not the first actuation operation has finished.

5. The method according to claim 4, wherein:
obtaining the value related to the electrical parameter comprises detecting variations in a first supply current of the electromagnetic driver of the first of the door actuator and the lock actuator, resulting in detected variations; and
the method further comprises, based on the detected variations, determining whether or not the first actuation operation has finished.

6. The method according to claim 5, further comprising determining that the first actuation operation has finished if no variations, for claim ripples, are detected in the first supply current.

7. The method according to claim 5, further comprising:
counting the detected variations resulting in an amount of counted variations;
comparing the amount of counted variations to a variation threshold; and
based on the comparing, determining whether or not the first actuation operation has finished.

8. The method according to claim 1, wherein:
a first sensor is provided arranged to generate the sensing signal, based on a position of a first moving part comprised by the first of the door actuator and the lock actuator;
the method further comprises receiving the sensing signal from the first sensor; and
the determining that the first actuation operation has finished is based on a sensing signal value of the sensing signal.

9. The method according to claim 1, further comprising:
performing a tolerance check comprising:
obtaining, from the sensing signal, a value of a range parameter, indicating a range of movement of the door actuator or the lock actuator;
determining whether or not the value falls within a predetermined tolerance interval; and
based on the outcome of the determining, determining whether or not the tolerance check was successful;
in dependence of the tolerance check, determining whether or not the door or the lock moves within the predetermined tolerance interval.

10. The method according to claim 9, wherein obtaining the value of the range parameter comprises:
performing a first tolerance check operation;
upon performing the first tolerance check operation, obtaining a first value related to the position of the door or the lock;
performing a second tolerance check operation;
upon performing the second tolerance check operation, obtaining a second value related to the position of the door or the lock;
comparing the first value and the second value; and
from the comparing, obtaining the value of the range parameter.

11-15. (canceled)

16. The method according to claim 1, wherein receiving the activation signal comprises receiving a signal from a controller of the vehicle.

17. A computer program product comprising instructions enabling a door actuation device comprising a first memory and a lock actuator device comprising a second memory, to execute a method according to claim 1.

18. A non-transitory medium having stored thereon the computer program product of claim 1

19. A lead actuator for operating a lead part, wherein the lead part comprises one of a door of a vehicle inlet port and a lock arranged to lock the door, the lead actuator comprising:
a lead electromagnetic driver;
a lead sensor inlet arranged to receive, from a lead sensor, a lead sensor signal indicating a lead position of the lead part;
a driving outlet arranged to provide a drive signal to the follow electromagnetic driver; and
a processing unit arranged to:
control the lead electromagnetic driver;
receive the lead sensor signal;
determine, based on the lead sensor signal, that the lead part has reached a destination lead position; and
upon determining that the lead part has reached the destination lead position, control the follow electromagnetic driver.

20. The lead actuator according to claim 19, further comprising a follow sensor inlet arranged to receive, from a follow sensor, a follow sensor signal indicating a follow position of a follow part, wherein the processing unit is further arranged to:
control the follow electromagnetic driver;
determine, based on the follow sensor signal, that the follow part has reached a destination follow position; and
upon determining that the follow part has reached the destination follow position, stop driving the follow electromagnetic driver.

21. The lead actuator according to claim 19, wherein the processing unit is further arranged to:
upon determining that the lead part has reached the destination lead position, stop driving the lead electromagnetic driver.

22. The lead actuator according to claim 20, to the extent dependent on claim 20, wherein the processing unit is further arranged to:
control the follow electromagnetic driver; and
upon determining that the follow part has reached the destination follow position, drive the lead electromagnetic driver.

23. The lead actuator according to claim 19, wherein the lead part comprises the door of the vehicle inlet port and the lead actuator is arranged to open and close the door.

24. The lead actuator according to claim 19, wherein the follow part comprises the lock of the vehicle inlet port and the follow actuator is arranged to lock and unlock the door.

25-26. (canceled)

27. A vehicle comprising:
an inlet port for receiving energy for propelling the vehicle;
a door for covering the inlet port;
a lock for locking the door; and a door actuator according to claim 19; and
a lock actuator for operating the lock, connected to the door actuator.
